(19) United States
(12) Patent Application Publication
(10) Pub. No.: US 2011/0225421 A1
(43) Pub. Date: Sep. 15, 2011

(54) METHOD OF OBTAINING CONTENT FOR MOBILE TERMINAL, MOBILE TERMINAL USING THE METHOD, AND NEAR FIELD COMMUNICATION SYSTEM HAVING THE MOBILE TERMINAL

(75) Inventors: Youngsun HAN, Suwon-si (KR); Taeseon Kim, Hwaseong-si (KR)

(73) Assignee: Samsung Electronics Co., Ltd, Suwon-si (KR)

(21) Appl. No.: 13/033,825

(22) Filed: Feb. 24, 2011

(30) Foreign Application Priority Data
Mar. 12, 2010 (KR) 2010-22352

(51) Int. Cl. H04L 9/32

(52) U.S. Cl. 713/159; 713/172; 713/155

(57) ABSTRACT

A method of operating a near field communication system includes receiving an electronic tag having information signed by using a private key, verifying the signed information of the electronic tag by using a public key corresponding to the private key, and connecting the mobile terminal to a content server using a result of the verification. The near-field communication system transfers the signed information of the smart poster by using the public key, and connects to the content server after verifying the signed information of the smart poster, thereby preventing malicious phishing using the smart poster.

### CROSS-REFERENCE TO RELATED APPLICATIONS

This U.S. non-provisional patent application claims the benefit of priority under 35 U.S.C. §119 of Korean Patent Application No. 2010-0022352, filed on Mar. 12, 2010, the entire contents of which are hereby incorporated by reference.

### BACKGROUND

### 1. Field of the Invention

The present general inventive concept disclosed herein relates generally to a mobile terminal, a near field communication system having the same, and method of using contents thereof.

Portable electronic devices, such as mobile phones and Personal Digital Assistants (PDAs), are frequently used for communication, such as for example, Short Field communication (SFC), Near Field Communication (NFC), and communication over a telecommunication network. However, the use of portable electronic devices is not limited to communication. They can also be used for to store context information, to store personal information, aggregating information, sharing data, listening music, and watching stored videos.

For example, a user of a mobile phone can store personal information or context information in the mobile device. Context information is any information that can be used to characterize the situation of an entity. An entity is a person, place, or object that is considered relevant to interaction between a user and an application. Further, the context information can change dynamically based on the environment of the user.

Through the use of electronic devices the user can share data, such as personal information and/or context information, with other electronic devices. The data can be shared between two electronic devices through a telecommunication network, a short range wireless communication network, and the like. For example, a mobile phone can share a data file with another electronic device through short range wireless communication, for example, short range radio (“Bluetooth®,” or “Bluetooth”), InfraRed light (IR), and NFC.

For sharing data using Bluetooth or IR, a user performs several manual activities, such as selecting data to be sent, activating a communication technique (for example, activating Bluetooth), searching for an electronic device in the vicinity of the mobile phone, selecting an electronic device to which the data is to be sent, and sending the data to the selected electronic device.

However, in NFC, which is a short-range high frequency wireless communication technology, a communication channel is established automatically as soon as two electronic devices are placed close proximity to one another. NFC enables the exchange of data between devices that are within about 10 centimeters (cm) of each other. Further, NFC is a short range wireless communication technology that has evolved from a combination of contactless, identification and networking technologies and is complementary to long range technologies. NFC utilizes particular standards different from Bluetooth systems, has a shorter range than Bluetooth, has a different data transfer rate than Bluetooth and SFC systems, and generally has a different mode of operation.

Thus, in NFC, manual intervention is minimized when data is exchanged and shared. Hence, it is more convenient for users to share data using NFC. But currently through NFC, only transfer of static data is possible. There exists no method in NFC for exchanging context information between a plurality of electronic devices. Also, the information cannot be aggregated and changed dynamically between a plurality of electronic devices.

### SUMMARY

Additional aspects and utilities of the present general inventive concept will be set forth in part in the description which follows and, in part, will be obvious from the description, or may be learned by practice of the present general inventive concept.

Features and/or utilities of the present general inventive concept may be realized by a method of using contents of a mobile terminal, the method including receiving an electronic tag having information signed by using a private key, verifying the signed information of the electronic tag by using a public key corresponding to the private key, and connecting the mobile terminal to a content server using a result of the verification.

The signed information of the electronic tag may be input by a near field communication connection technology.

The electronic tag may be a smart poster.

The smart poster may include at least one encryption bit indicating that the smart poster may be signed, content provider information indicating information on a provider of the content server corresponding to the public key, and uniform resource locator (URL) information signed by using the private key for connecting the mobile terminal to the content server.

The private key may be allocated to the provider of the content server or a chip outputting the signed information of the electronic tag from an external certification server.

The method may include determining whether the public key corresponding to the private key is stored in the mobile terminal after the electronic tag is input.

The mobile terminal requests the public key to the certification server when there is no the public key in the mobile terminal.

The mobile terminal stores the public key input from the certification server according to the request.

The method may further include requesting a certification of the mobile terminal by the content server.

Features and/or utilities of the present general inventive concept may also include a content server to provide content to a network, a smart poster chip to store a smart poster having information signed by using a private key and transferring the signed information of the smart poster using near field communication connection technology, a mobile network operator to allocate the private key to the content server or the smart poster chip and to store a public key corresponding to the private key, and a mobile terminal configured with the NFC connection technology to input the signed information of the smart poster when the mobile terminal approaches the smart poster chip, to verify the input signed information of the smart poster by using the public key, and to connect to the content server according to a result of the verification of the signed information.

The content server may perform a fee certification or a ratings certification of the mobile terminal for connecting to the content server.

The mobile network operator includes a certification server to allocate the private key and to store the public key.

The mobile terminal may include an NFC module to receive the signed information of the smart poster from the smart poster chip, an application processor to receive the signed information from the NFC module and to connect to the content server according to the result of the verification, and a subscriber identity module (hereafter, ‘SIM’) card to connect the NFC module according to a single wire protocol, to receive the signed information from the NFC module, and to verify the signed information by using the public key.

The SIM card may include a key storage unit to store the public key, and a key management unit to manage public keys stored in the key storage unit.

The application processor may request the public key from the mobile network operator when the public key is not stored in the key storage unit of the SIM card.

A mobile terminal according to the present general inventive concept may include a near field communication module receiving an electronic tag according to a NFC connection technology, The electronic tag includes information signed by using a private key, an application processor receiving the signed information for the electronic tag from the NFC module, determining whether to verify the signed information of the input electronic tag, and determining whether to connects to an external content server according to a result of the verification of the signed information, and a subscriber identity module card to store private information to manage the application processor and verifying the signed information of the electronic tag.

The signed information of the electronic tag may be signed by using the private key allocated to a provider of the content server.

The signed information of the electronic tag may be verified by using a public key corresponding to the private key.

The public key may be provided from a certification server, and the certification server may allocate the private key to the provider of the content server and may store the public key.

The private key and the public key may be generated by an RSA encryption system.

Features and/or utilities of the present general inventive concept may also be realized by a method of obtaining content in a mobile device, the method including receiving via near-field communication information corresponding to a content server, verifying the received information by comparing first identifying information in the received information to stored second identifying information, and accessing the content server only when the received information is verified.

The received information may include content provider information corresponding to the content server and signed information including the first identifying information.

The first identifying information may be a private key and the second identifying information may be a public key.

Verifying the received information may be performed by the mobile device, and the method may further include, when it is determined that the second identifying information is not stored in the mobile device, accessing with the mobile device a mobile network operator to request the second identifying information.

The method may further include, before verifying the received information, determining a value of an encrypted bit of the received information, and verifying the received information may be performed only if the encrypted bit corresponds to a predetermined value.

The method may further include downloading content from the content server.

Features and/or utilities of the present general inventive concept may also be realized by a mobile device including a near field communication module to receive information from a near field communication device, a verification module to compare first identification in the received information with second identification stored in the verification module, and a control unit to access a content provider indicated by the received information only when the first identification corresponds to the second identification.

When it is determined that the second identification is not stored in the verification module, the control unit may access a network provider to receive the second identification and may transmit the second identification to the verification unit.

The verification unit may be a SIM card.

The received information may include content provider information and signed information, the verification module may access the first identification from the signed information, and the control unit may access the content provider based on the content provider information.

Features and/or utilities of the present general inventive concept may also be realized by a near field communication system, including a content server connected to a network to transmit content to the network, a mobile network operator to store a first identification and a second identification, a near filed communication chip to receive the first identification from the mobile network operator, and a mobile terminal to receive information including the first identification from the near field communication chip, to receive the second identification from the mobile network operator, to verify the information received from the near field communication chip based on a comparison of the first identification and the second identification, and to receive the content transmitted from the content server only when the first identification received from the near field communication chip corresponds to the second identification received from the mobile network operator.

The mobile terminal may include a near field communication module to receive the information from the near field communication chip, a verification module to compare the first identification in the received information with the second identification stored in the verification module, and a control unit to access the content server indicated by the received information only when the first identification corresponds to the second identification.

### BRIEF DESCRIPTION OF THE DRAWINGS

The accompanying figures are included to provide a further understanding of the present general inventive concept, and are incorporated in and constitute a part of this specification. The drawings illustrate exemplary embodiments of the present general inventive concept and, together with the description, serve to explain principles of the present general inventive concept. In the figures:

FIG. 1 is a diagram illustrating a near field communication system 10, in accordance with an embodiment of the present general inventive concept.

FIG. 2 is a diagram illustrating that the near field communication system 10 in FIG. 1 is secured from an attack of a phishing server.

FIG. 3 is a diagram illustrating an embodiment of information transmitted from the smart poster in FIG. 1.

FIG. 4 is a first flowchart illustrating a method of using contents according to the present general inventive concept when the public key is not stored in the SIM card.

FIG. 5 is a first flowchart illustrating a method of using contents according to the present general inventive concept when the public key is stored in the SIM card.

FIG. 6 is a second flowchart illustrating a method of using contents according to the present general inventive concept when the public key is not stored in the SIM card.

FIG. 7 is a second flowchart illustrating a method of using contents according to the present general inventive concept when the public key is stored in the SIM card.

FIG. 8 is a diagram illustrating a near field communication system according to an embodiment of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

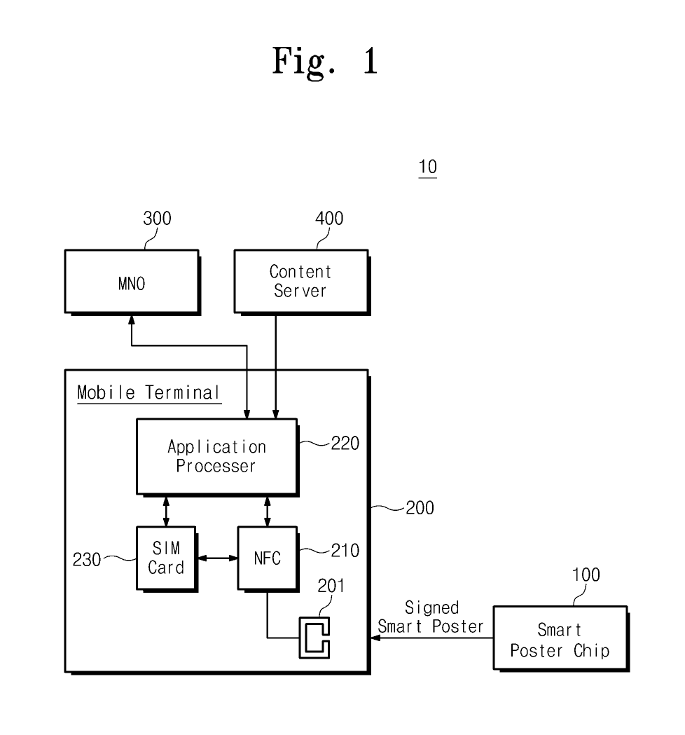

FIG. 1 is a diagram illustrating a near field communication system 10, in accordance with an embodiment of the present general inventive concept. Referring to FIG. 1, the near field communication system 10 includes a smart poster chip 100, a mobile terminal 200, a mobile network operator 300, and a content server 400.

The smart poster chip 100 may store signed information. The signed information can be called the signed smart poster or smart poster information. The signed information of the smart poster includes information regarding connection contents. The information on the connection contents may include a content provider, a URL (Uniform Resource Locator), etc., to allow the mobile terminal 200 to access another device, such as a content server 400 on a network.

For example, the signed information of the smart poster may include an address of an internet homepage, a network address of a content server 400 from which to download content to the mobile terminal 200, or other data to allow the mobile terminal 200 to receive content from a source other than the smart poster chip 100. The smart poster chip 100 outputs the signed information of the smart poster when the mobile terminal 200 approaches the smart poster chip 100. For example, when the mobile terminal 200 comes within 10 cm of the smart poster chip 100, the smart poster chip 100 may transmit the smart poster information to the mobile terminal 200. The signed information is signed by using a private key of the content provider or the smart poster chip 100. The private key is allocated from the mobile network operator 300.

In other words, each smart poster chip 100 corresponding to a particular content server 400 may have a particular private key provided to the smart poster chip 100 or the content server 400 corresponding to the smart poster chip 100, and the private key is provided to the smart poster chip or the content server 400 by the mobile network operator 300. Thus, users of the mobile network operator 300 may access content servers 400 approved by the mobile network operator 300. A public key corresponding to the private key is stored in the mobile network operator 300. The mobile terminal 200 may receive the corresponding public key from the mobile network operator 300 to identify the private key from the smart poster chip 100, so that the public key is used to verify the signed information of the smart poster.

While FIG. 1 illustrates one example of a smart poster chip 100, the smart poster chip 100 in the near field communication system of the present general inventive concept is not limited thereto. The near field communication system may use any kind of an electronic tag. For example, the electronic tag may be a RFID (Radio Frequency IDentification). The electronic tag according to embodiments of the present general inventive concept may include the information signed by using the private key.

The mobile terminal 200 may perform near field communication by means of the NFC module 210. As discussed above, NFC is a short-range wireless technology to communicate between two electronic devices. NFC is typically a high-frequency communication method and may operate around 14 MHz, such as at 13.56 MHz. NFC may utilize magnetic field induction to generate an RF field to communicate between two devices that are located close to one another, such as within about 10 cm of each other.

The devices having a NFC function may exchange data through manual mode or active mode. In manual mode, a NFC initiator may supply an RF field in a communication session. The NFC initiator sends data into a NFC target in a speed of 106 Kbps or 424 Kbps. The NFC target need not generate the field, but sends data to the NFC initiator at a same speed using load modulation technology. This type of communication mechanism may be compatible with contactless smart cards, and the NFC initiator of manual mode may detect and establish a contact using the same connection and an initialization procedure as are used with smart cards.

In active mode, each of the devices has to generate an independent RF field when it sends data to other devices. The NFC initiator and NFC targets generate independent RF fields to provide good communications between the initiator and the target. The active mode, which is a standard mode for Peer-to-Peer communication, makes it possible to achieve a higher-speed connection than the manual mode.

The mobile terminals that operate primarily in manual mode may extend the battery life of an initiator and/or target by consuming less power than devices that operate primarily in the active mode. NFC devices may act as either the NFC initiator or the NFC target, depending upon the device and the circumstances in which it is used. Consequently, a device that has a low charge in its battery can be used as the NFC target of manual mode instead of the NFC initiator to conserve power.

The mobile terminal 200 includes an antenna 201, a NFC module 210, an application processor 220, and a SIM card 230.

The antenna 201 receives the signed information of the smart poster using wireless communication protocols.

The NFC module 210 may receive the signed information of the smart poster through the antenna 201 from the smart poster chip 100, and may transfer the signed information to the application processor 220. The NFC module 210 may transfer the signed information using a communication protocol according to the command of the application processor 220 for verifying of the signed information. The communication protocol may be a single wire protocol (SWP).

The application processor 220 may control all operations of the mobile terminal 200. The mobile terminal 200 may include one or more microphones, speakers, display devices, cameras, communication modules, RAM for temporarily storing data, flash memory devices, etc. The application processor 220 may control the above variable devices in the mobile terminal 200 by processing input data and/or commands from a user interface or from an interface with another device. The application processor 220 may include a CPU (Central Processor Unit), a nonvolatile memory device to store control data and a volatile memory to store a temporal data etc.

The application processor 220 may receive the signed information from the NFC module 210 and may determine whether to verify the signed information. The application processor 220 may determine whether the public key to verify signed information is stored in the SIM card 230. If the public key is not stored in the SIM card 230, the application processor 220 may request the public key from the mobile network operator 300. The public key may be transferred from the mobile network operator 300 base at the request of the application processor 220, and the public key may be transferred to the SIM card 230 through the NFC module 210.

The application processor 220 may receive a result of the verification of the signed information from the SIM card 230 through the NFC module 210, and may try to connect to the content server 400 according to the result of the verification. The near field communication function of the application processor 220 and the NFC module 2010 are commonly called NFC solutions. In other words, when the application processor 220 verifies the identity of the smart poster chip 100 by verifying that the signed information from the smart poster chip 100 corresponds to the public key stored in the SIM card 230, the application processor 220 may connect to the content server 400 indicated by the information received from the smart poster chip 100 by accessing address information in the data received from the smart poster chip 100.

The SIM card 230 may store private information of the mobile terminal 200, and may verify the signed information of the smart poster by using the public key. The SIM card 230 may include a key storage unit (not shown) to store the public key. In addition, the SIM card 230 may include a key management unit (not shown) to manage the stored public key in the key storage unit. For example, the key storage unit may be configured to not store the public keys more than a predetermined number or for longer than a predetermined period of time.

In addition, the management of the public keys may be controlled such that public keys corresponding to content servers 400 that are accessed more often are stored in the SIM card 230 longer or even indefinitely, compared to public keys corresponding to seldom-accessed content servers.

The mobile network operator 300 may correspond to the entity that provides network services to a community of users of a plurality of mobile terminals. The mobile network operator 300 may allocate the private key to the content provider or the smart poster chip 100 to issue the smart poster. The private key may be allocated from a certification server of a certificate authority insured by the mobile network operator 300, for example.

The content server 400 may provide content to the mobile terminal 200. The content server 400 may provide content to the mobile terminal 200 once the mobile terminal 200 has verified, using the public key from the mobile network operator 300 and the private key or signed smart poster from the smart poster chip 100, the identity of the content server 400. Thus, the smart poster chip 100 may provide verification data and data identifying the content server 400 to the mobile terminal 200. In contrast, the content server 400 provides content to the mobile terminal 200. Content may be defined as data to provide additional functionality to the mobile terminal 200. For example, the content may include audio or video data to allow the mobile terminal 200 to perform an audio or video function. The content may include a computer program to allow the mobile terminal to make purchases, provide displays to a user, or provide other programs to a user, such as games, word processing programs, accounting programs, spreadsheet programs, presentation programs, organizational programs, or any other type of program. The content is distinguished from the information provided from the smart poster chip 100, because the smart poster chip 100 provides only data to allow the mobile terminal 200 to communicate with a content server 400, while the content allows the mobile terminal 200 to perform an additional or new function other than verification. In other words, while the smart poster chip 100 only causes the mobile terminal 200 to perform a verification process, the content provided from the content server 400 is received after the verification process and allows the mobile terminal 200 to perform a particular new or additional function or operation, other than verification.

The near field communication system 10 may generate a pair of private key and public key by using a public encryption system. The public encryption system may be an RSA (Rivest, Shamir, Adleman) encryption system.

The near field communication system 10 according to an embodiment of the general inventive concept transfers the information signed by using the public key, and connects the mobile terminal to the content server after verifying the signed information, thereby preventing malicious phishing using the smart poster.

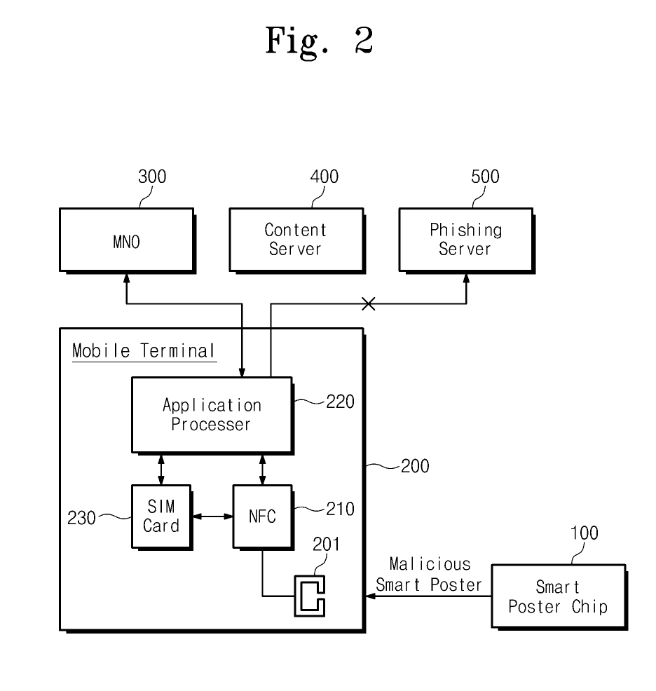

FIG. 2 is a diagram illustrating that the near field communication system 10 in FIG. 1 is secured from an attack of the phishing server 500. Referring to FIG. 2, the smart poster chip 100 may output information of the smart poster when the mobile terminal 200 approaches. The smart poster chip 100 may output information of a malicious smart poster stored by the attacker. The output information of the malicious smart poster is not signed by a legal private key.

The antenna 201 of the mobile terminal 200 receives the information from the malicious smart poster and transfers it to the NFC module 210. The NFC module 210 may transfer the information of the malicious smart poster to the application processor 220. Then the application processor 220 may determine whether to verify the information. However, since the information is not signed using a private key provided by the MNO 300, and since the public key is not stored in the SIM card 320 or the mobile network operator 300, the verification cannot be performed. Therefore, the application processor 220 is prevented from connecting to the phishing server 500. As a result, the near field communication system 10 according to the present general inventive concept may intercept effectively the access from the mobile terminal 200 to the phishing server 500.

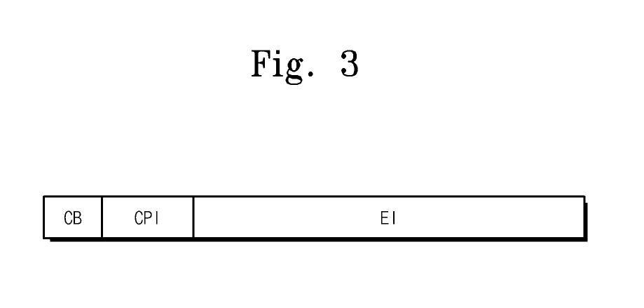

FIG. 3 is a diagram illustrating an embodiment of the information of the smart poster in FIG. 1. Referring to FIG. 3, the information of the smart poster may include an encryption bit CB, content provider information CPI, signed information EI.

The encryption bit CB is a bit indicating whether the information of the smart poster is encrypted. Then the application processor 220 (Referring to FIG. 1) may determine whether to verify the signed information according to the encryption bit CB.

The content provider information CPI is information in relation with the content server 400 (Referring to FIG. 1) that provides content. For example, the content provider information CPI may be the information of film makers (e.g., WB), a software content provider, or any other type of content provider. The public key corresponding to the content provider information CPI may be stored in the mobile network operator 300 and/or the SIM card 230.

When the public key corresponding to the content provider information CPI is stored in the SIM card 230, the signed information EI is verified by using the public key, and the mobile terminal 200 is permitted to access the content server 400 of the content provider.

However, if the public key corresponding to the content provider information CPI is not stored in the SIM card 230, the application processor 220 (Referring to FIG. 1) may request the public key from the mobile network operator 300 and may download the public key transferred from the mobile network operator 300. The downloaded public key may be stored in the SIM card 230 through the NFC module 210. The SIM card 230 may verify the signed information using the stored public key.

The signed information EI may include the signed URL information to connect the application processor 220 to the content server 400. The URL information may be signed by using the private key. The private key is allocated to the content provider that controls or operates the content server 400 and smart poster chip 100 by the mobile network operator 300.

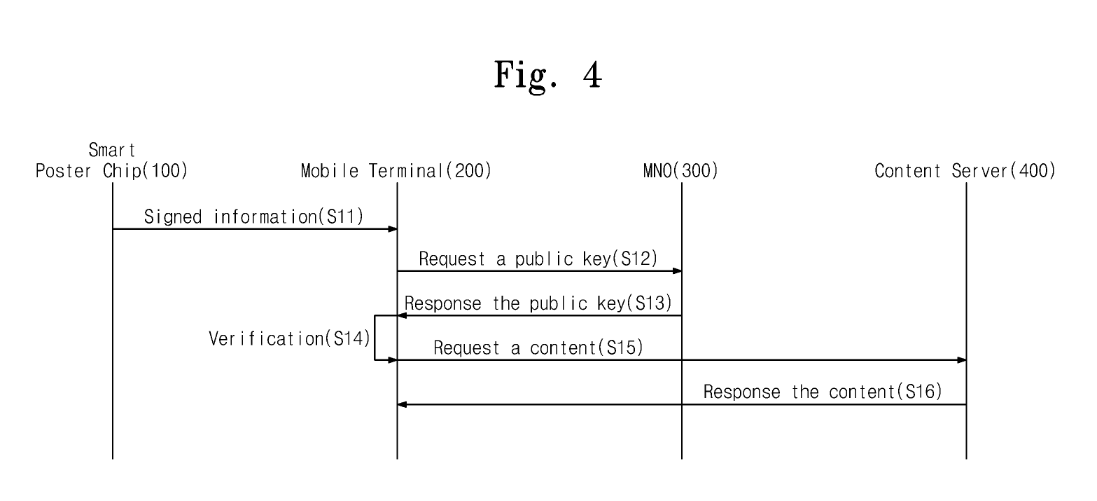

FIG. 4 is a first flowchart illustrating a method of using contents according to the present general inventive concept when there is no the public key in the SIM card 230. Referring to FIG. 1, FIG. 3 and FIG. 4, the method of using contents is performed as follows. First, the smart poster chip 100 may transfer the signed information (EI) of the smart poster into the mobile terminal 200 in operation S11 when the mobile terminal 200 approaches the smart poster chip 100. The signed information is signed by using the private key of the content provider operating the content server 400 or smart poster chip 100.

The mobile terminal 200 may receive the signed information, and may determine whether to perform a verification process of the received signed information. Determining whether to perform the verification process may be performed according to the encryption bit CB of the smart poster. For example, if the application processor 220 does not recognize the encryption bit CB, the application processor 220 may determine that the verification process should not proceed. When the public key corresponding to the private key provided by the smart poster chip 100 is not stored in the SIM card 230, the mobile terminal 200 may request the public key from the mobile network operator 300 in operation S12. The requested public key corresponds to the content provider information CPI (Referring to FIG. 3).

The mobile network operator 300 may transfer the public key to the mobile terminal 200 in operation S13 in response to the request for the public key. The mobile terminal 200 receives the public key from the mobile network operator 300, and verifies the signed information by using the input public key in operation S14. This verification is performed in the SIM card 230. The public key received from the MNO 300 may be stored in the SIM card 230.

The smart poster may include the information in relation with the content server 400, such as network address information. The application processor 220 may request the content from the content server based on this information in operation S15. The content server 400 may transfer the content to the mobile terminal 200 in operation S16 according to the request of the application processor 220.

As described above, when the public key is not stored in the SIM card 230, content may be received from a content server 400 by requesting a public key from the mobile network operator 300, verifying the signed information by using the public key received from the mobile network operator 300, and downloading the content from the content server based on the result of the verification.

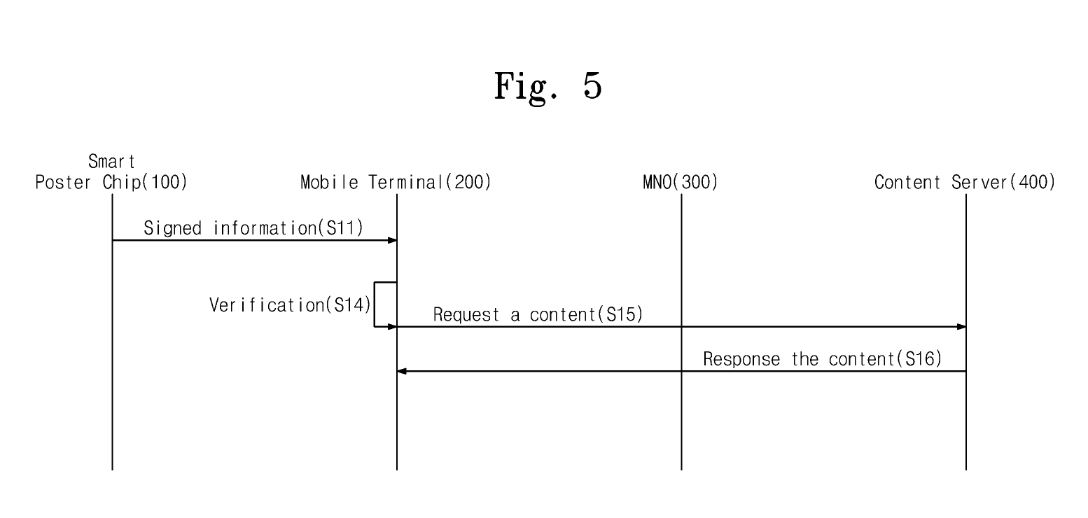

FIG. 5 is a flowchart illustrating a method facilitating the transmission of content from a content server 400 to a mobile terminal 200 according to the present general inventive concept when the public key is stored in the SIM card 230. Referring to FIG. 1, FIG. 3 and FIG. 5, the smart poster chip 100 may transfer the signed information to the mobile terminal 200 in operation S11 when the mobile terminal 200 approaches the smart poster chip 100. The signed information is signed by using the private key of the content provider operating the content server 400 or smart poster chip 100.

The mobile terminal 200 may receive the signed information from the smart poster chip 100, and may determine whether to verify the received signed information. The determination of verification may be determined according to the encryption bit CB (Referring to FIG. 3) of the signed information. When the public key to verify the signed information is stored in the SIM card 230, the SIM card 230 may verify the signed information using the public key in operation S14.

The smart poster may include the information in relation with the content server to connect. The application processor 220 may request the content from the content server 400 in operation S15 based on this information. The content server 400 may transfer the contents to the mobile terminal 200 in operation S16 according to the request of the application processor 220.

As described above, when the public key is stored in the SIM card 230, the method of transmitting content to the mobile terminal 200 includes verifying the signed information of the smart poster by using the public key stored in the SIM card 230 and downloading the content from the content server 400 based on the result of the verification.

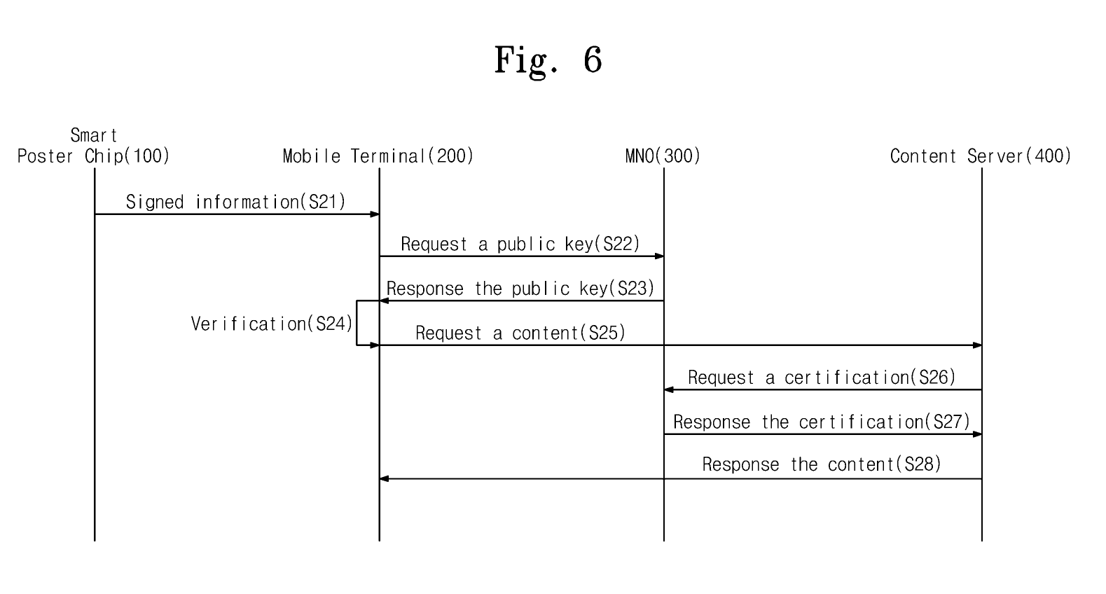

FIG. 6 is a second flowchart illustrating a method of transmitting content from a content server 400 to a mobile terminal 200 according to an embodiment of the present general inventive concept when the public key is not stored in the SIM card. Compared to FIG. 4, the method described in FIG. 6 further includes requesting the certification of the mobile network operator 300 by the content server 400 in operation S26 and receiving the response to the requested certification by the content server in operation S27.

In other words, after the mobile terminal 200 requests the public key from the mobile network operator 300 and verifies the identity of the content provider corresponding to the smart poster chip 100, the content provider 400 may request a certification from the mobile network operator 300 of particular information. For example, the content server 400 may request at least one certification for obtaining an approval of a fee, such as a certification fee, or determining the user ratings (a ratings certification). The mobile network operator 300 may notify the content server 400 that the fee is paid or the user ratings are determined in response to the request on the certification.

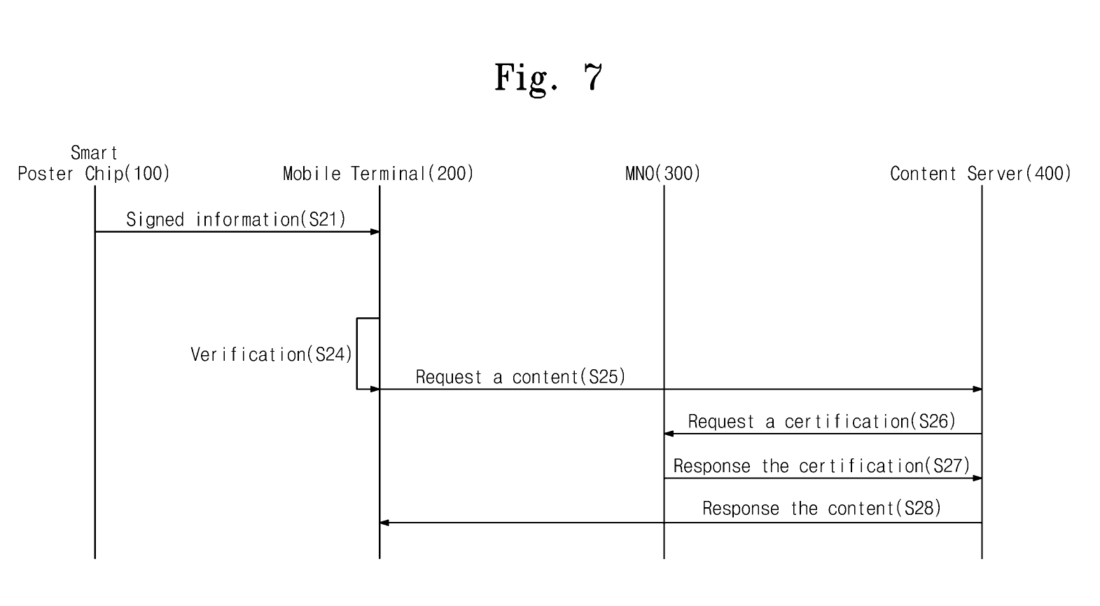

FIG. 7 is a second flowchart illustrating a method of using contents according to the present general inventive concept when the public key is stored in the SIM card 230. Compared to the method illustrated in FIG. 5, the method illustrated in FIG. 7 includes requesting the certification of the mobile network operator 300 by the content server 400 in operation S26 and receiving the response regarding the requested certification from the content server in operation S27.

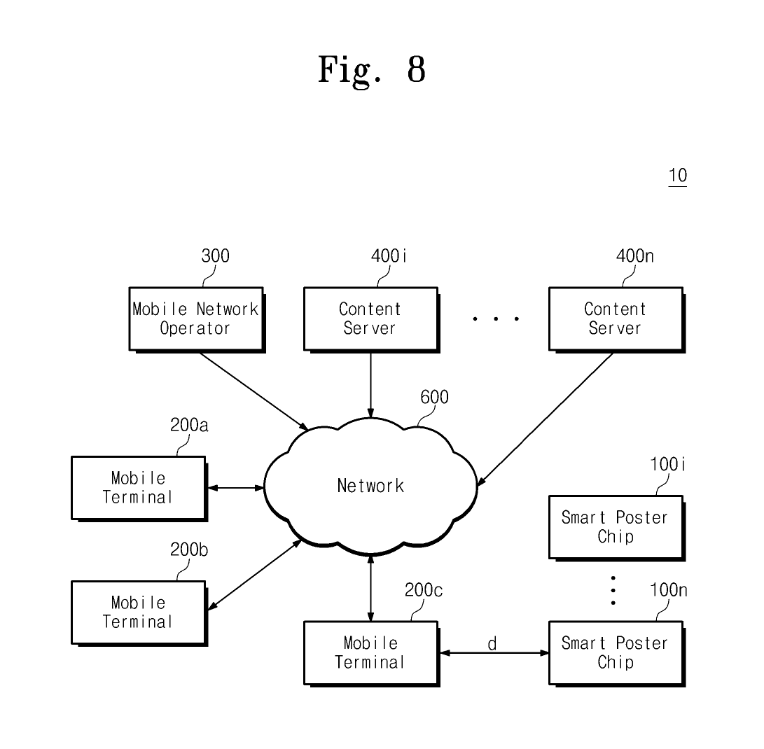

FIG. 8 illustrates a near-field communication system 10 according to an embodiment of the present general inventive concept. As illustrated in FIG. 10, a plurality of mobile terminals 200a, 200b, and 200c is connected to a network 600. The network 600 may be the Internet, a local area network, wide area network, or any other type of network. The network 600 may also comprise a combination of networks. For example, the mobile terminals 200a, 200b, and 200c may be connected to the mobile network operator 300 via one type of network, such as a wireless LAN or cellular network, and to the content servers 400i-400n via a second type of network, such as the Internet.

The mobile network operator 300 and a plurality of content servers 400i-400n are connected to the network to communicate with the mobile terminals 200a, 200b, and 200c in the manner described above. A plurality of smart poster chips 100i-100n is provided to communicate with each of the mobile terminals 200a, 200b, and 200c. Each smart poster chip 100i-100n corresponds to a respective content server 400i-400n. When a mobile terminal comes within a distance d of the smart poster chips, the respective smart poster chip communicates with the mobile terminal in the manner described above to initiate the verification and content-providing process. In this manner, each mobile terminal 200a, 200b, and 200c may communicate with any one of a plurality of smart poster chips 100i-100n to receive content from a respective content server 400i-400n. In addition, the mobile network operator 300 may communicate with the smart poster chips 100i-100n to provide the smart poster chips with identification information, such as a private key. The mobile network operator 300 may communicate with the smart poster chips 100i-100n indirectly, such as by providing the private key to a content provider that manufactures or programs the smart poster chips 100i-100n.

In embodiments of the present general inventive concept, a mobile terminal may include an NFC module to receive an electronic tag according to a NFC connection technology, the electronic tag includes information signed by using a private key, an application processor to receive the signed information for the electronic tag from the NFC module, to determine whether to verify the signed information of the input electronic tag, and to determine whether to connect to an external content server according to a result of the verification of the signed information, and a SIM card to store private information to manage the application processor and to verify the signed information of the electronic tag.

The signed information of the electronic tag is signed by using the private key allocated to a provider of the content server by the mobile network operator.

The signed information of the electronic tag is verified by using a public key corresponding to the private key.

The public key is provided from a certification server, and the certification server allocates the private key to the provider of the content server and stores the public key.

The private key and the public key may be generated by an RSA encryption system.

The above-disclosed subject matter is to be considered illustrative, and not restrictive, and the appended claims are intended to cover all such modifications, enhancements, and other embodiments, which fall within the true spirit and scope of the present general inventive concept. Thus, to the maximum extent allowed by law, the scope of the present general inventive concept is to be determined by the broadest permissible interpretation of the following claims and their equivalents, and shall not be restricted or limited by the foregoing detailed description.

1. A method of enabling communication with a mobile terminal, the method comprising:
receiving an electronic tag having information signed by using a private key;
verifying the signed information of the electronic tag by using a public key corresponding to the private key; and
connecting the mobile terminal to a content server using a result of the verification.

2. The method of claim 1, wherein the signed information of the electronic tag is input by a near field communication (NFC) connection technology.

3. The method of claim 1, wherein the electronic tag is a smart poster.

4. The method of claim 1, wherein the smart poster includes at least one encryption bit indicating that the smart poster is signed;
content provider information indicating information on a provider of the content server corresponding to the public key; and
uniform resource locator (URL) information signed by using the private key to connect the mobile terminal to the content server.

5. The method of claim 1, wherein the private key is allocated to the provider of the content server or a chip outputting the signed information of the electronic tag from an external certification server.

6. The method of claim 5, further comprising:
determining whether the public key corresponding to the private key is stored in the mobile terminal after the electronic tag is input.

7. The method of claim 6, wherein the mobile terminal requests the public key from the certification server when there is no the public key in the mobile terminal.

8. The method of claim 7, wherein the mobile terminal stores the public key input from the certification server.

9. The method of claim 1, further comprising:
requesting a certification of the mobile terminal by the content server.

10. A near field communication system, comprising:
a content server to provide data content to a network;
a smart poster chip to store a smart poster having information signed by using a private key and to transfer the signed information of the smart poster according to a near field communication (hereafter, ‘NFC’) connection technology;
a mobile network operator to allocate the private key to the content server or the smart poster chip and to store a public key corresponding to the private key; and
a mobile terminal configured with the NFC connection technology to input the signed information of the smart poster when the mobile terminal approaches the smart poster chip, to verify the input signed information of the smart poster by using the public key, and to connect to the content server according to a result of the verification of the signed information.

11. The near field communication system of claim 10, wherein the content server performs a fee certification or a ratings certification of the mobile terminal before the content server provides content to the mobile terminal to the content server.

12. The near field communication system of claim 10, wherein the mobile network operator includes a certification server for to allocate the private key and to store the public key.

13. The near field communication system of claim 9, wherein the mobile terminal comprises:
an NFC module to receive the signed information of the smart poster from the smart poster chip;
an application processor to receive the signed information from the NFC module and to connect to the content server according to the result of the verification; and
a subscriber identity module (hereafter, ‘SIM’) card to connect the NFC module according to a single wire protocol, to receive the signed information from the NFC module, and to verify the signed information by using the public key.

14. The near field communication system of claim 13, wherein the SIM card comprises:
a key storage unit to store the public key; and
a key management unit to manage public keys stored in the key storage unit.

15. The near field communication system of claim 15, wherein the application processor requests the public key from the mobile network operator when the public key is not stored in the key storage unit of the SIM card.

16. A mobile terminal, comprising;
a near field communication (hereafter, “NFC”) module to receive an electronic tag according to an NFC connection technology, wherein the electronic tag includes information signed by using a private key;
an application processor to receive the signed information for the electronic tag from the NFC module, to determine whether to verify the signed information of the input electronic tag, and to determine whether to connect to an external content server according to a result of the verification of the signed information; and
a subscriber identity module (hereafter, ‘SIM’) card to store private information to manage the application processor and to verify the signed information of the electronic tag.

17. The mobile terminal of claim 16, wherein the signed information of the electronic tag is signed by using the private key allocated to a provider of the content server.

18. The mobile terminal of claim 17, wherein the signed information of the electronic tag is verified by using a public key corresponding to the private key.

19. The mobile terminal of claim 18, wherein the public key is provided from a certification server, and
the certification server allocates the private key to the provider of the content server and stores the public key.

20. The mobile terminal of claim 19, wherein the private key and the public key are generated by an RSA encryption system.

21.-32. (canceled)
